(19) United States
(12) Patent Application Publication
(10) Pub. No.: US 2009/0010649 A1
(43) Pub. Date: Jan. 8, 2009

(54) Optical access network with legacy support

(75) Inventors: Muneer Zuhdi, (US); Ricardo E. Saad, Plano, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Bedford, Inc.

(21) Appl. No.: 11/880,869

(22) Filed: Jul. 23, 2007

Related U.S. Application Data
(63) Continuation-in-part of application No. 11/824,661, filed on Jul. 2, 2007.

(51) Int. Cl. H04J 14/02

(52) U.S. Cl. 398/59

(57) ABSTRACT

An optical access network system can be used to upgrade legacy passive optical networks by subdividing currently used optical bands (e.g., C-, S-, or O-bands) into subbands to support more wavelengths. The subbands can be used to provide various current or emerging services to end users. Optical transmitters may selectively transmit modulated/unmodulated optical signals in multiple subbands downstream. Demultiplexers demultiplex the optical signals into respective bands and subbands for delivery to multiple respective destinations. Optical transceivers may receive and modulate downstream, unmodulated, optical signals (e.g., in the optical O-band) and transmit the modulated optical signals upstream. Upgrades to legacy systems or future systems can be implemented in a cost effective manner with negligible, if any, disruptions in service noticed by the end user.

### RELATED APPLICATION

This application is a continuation-in-part of U.S. application Ser. No. 11/824,661, filed on Jul. 2, 2007. The entire teachings of the above application are incorporated herein by reference.

### BACKGROUND OF THE INVENTION

Passive optical networks are currently used in telecommunications to provide network services to end users. Example services include telephone, cable television, and the Internet. Passive optical networks, as used in current practice, typically include a service provider network, optical line terminal, multiplexer/demultiplexer, optical network units or terminals, and end user equipment connected via interconnections by optical fiber. Implementation of currently used passive optical networks has been expensive and is widely used. Therefore, continued use of currently used passive optical networks in future network designs would be cost effective.

### SUMMARY OF THE INVENTION

An example embodiment of the invention provides an apparatus to distribute optical signals in a passive optical network. The apparatus includes a coarse demultiplexer that may be configured to separate an optical signal into at least two optical bands and at least one fine demultiplexer that may be configured to separate one particular band of the at least two optical bands into multiple subbands to distribute optical signals in the optical network.

Another example embodiment of the invention provides an optical network apparatus with first optical transmitters that may be configured to transmit optical signals in multiple first subbands of a first optical wavelength band to multiple downstream destinations in the optical network and second optical transmitters that may be configured to transmit optical signals in multiple second subbands of a second optical wavelength band to at least a subset of the multiple destinations in the optical network.

Another example embodiment of the invention includes an apparatus for supporting communications in an optical network. The apparatus includes an optical transmitter that may be configured to transmit at least one continuous wave optical signal in a downstream direction in an optical network and a first optical receiver that may be configured to receive and modulate the at least one continuous wave optical signal to produce a modulated at least one continuous wave optical signal and direct the modulated at least one continuous wave optical signal upstream to a second optical receiver to support upstream communications in the optical network.

Another example embodiment of the invention may be an apparatus for supporting communications in an optical network in which a first optical transmitter may be configured to transmit at least one continuous wave optical signal in a downstream direction in an optical network and a second optical transmitter may be configured to transmit optical signals in multiple subbands of an optical wavelength band to multiple downstream destinations in the optical network.

Another example embodiment of the invention may be an apparatus for supporting communications in an optical network. The apparatus may include multiple continuous wave sources configured to generate optical signals in respective subbands in the optical O-band to provide carrier wavelengths to be modulated at a network node other than a network node with the sources to produce a modulated wavelength division multiplexed optical signal.

Another example embodiment of the invention includes an optical network device that may be an optical transceiver coupled to an optical path to modulate a continuous wave carrier wavelength received in a downstream direction to produce a modulated optical signal and to transmit the modulated optical signal in an upstream direction via the optical path or a different upstream optical path.

Another example embodiment of the invention may be an optical network system. The optical network system may include the following: first optical transmitters selectably configured to transmit optical signals in multiple first subbands of an optical wavelength first band to at least a subset of multiple downstream destinations in the optical network system; second optical transmitters selectably configured to transmit optical signals in multiple second subbands of an optical wavelength second band to at least a subset of the multiple destinations in the optical network system; third optical transmitters selectably configured to transmit optical signals in multiple third subbands of an optical wavelength third band to at least a subset of the multiple destinations in the optical network system; a coarse demultiplexer configured to separate optical wavelength bands into at least two bands, including separating the first band, second band, and third band; at least one fine demultiplexer configured to separate at least one of the first, second, and third bands into multiple first, second, or third respective subbands to distribute optical signals in the optical network system; and an optical transceiver selectably configured to receive optical signals of the first, second, or third bands, to modulate the optical signals of at least one of the first, second, or third bands, and to transmit modulated optical signals to another node in the network.

It should be understood that embodiments of the present invention include methods corresponding to the example apparatus embodiments.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram that illustrates an example passive optical network as configured under current practice in which embodiments of the invention may be employed.

FIG. 2 is a frequency chart that depicts typical wavelength bands within which digital or analog upstream or downstream optical signals may be transmitted in an optical network.

FIG. 3A is a first of two schematic diagrams that together illustrate network components that support multiple example passive optical network configurations in accordance with example embodiments of the invention.

FIG. 3B is a second of two schematic diagrams that together illustrate network components that support multiple example passive optical network configurations in accordance with example embodiments of the invention.

FIG. 4 is a diagram that illustrates an example passive optical network in accordance with an example embodiment of the invention.

FIGS. 5-11 are flow diagrams that illustrate methods in accordance with example embodiments of the invention.

### DETAILED DESCRIPTION OF THE INVENTION

A description of example embodiments of the invention follows.

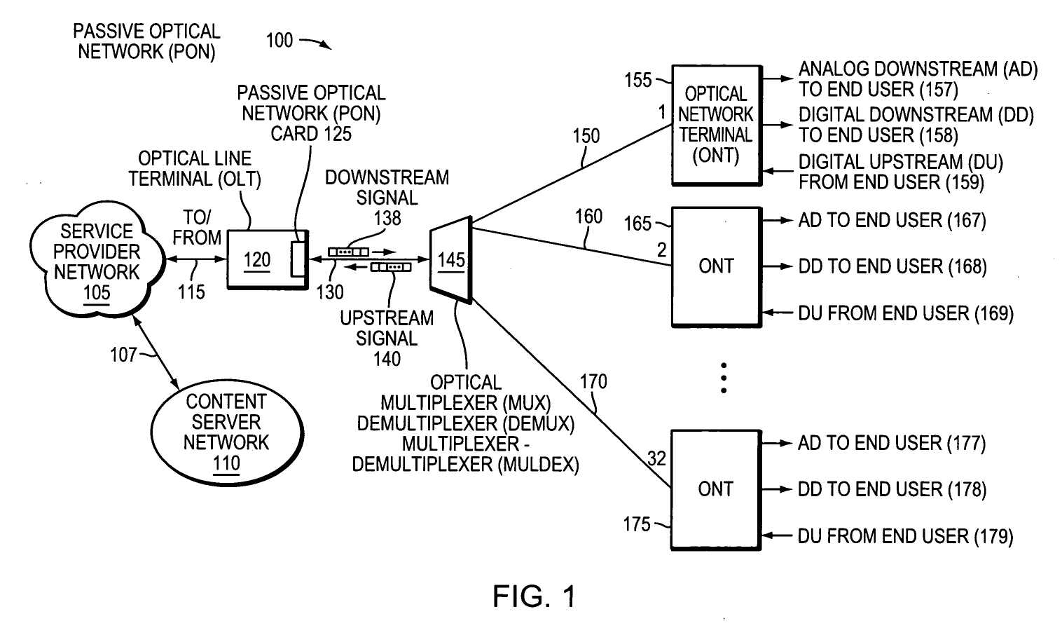

FIG. 1 illustrates an example passive optical network 100 as configured under current practice. The passive optical network (PON) 100 is a network of optical fibers that are arranged in an architecture that includes at least one non-powered optical splitter/combiner and communicates and transmits optical signals to multiple end users. the PON 100 is employed in some networks as an access network to allow end users to access content available in a network to which the access network is connected. It should be understood that, unless otherwise specified, the term “connections” as used herein refers to optical fibers or free-space optical paths and may include physical hardware or logical connections associated therewith.

The PON 100 includes a service provider network 105 that may be connected 107 to a content server network 110 via optical or electrical communications paths or links. The service provider network 105 may also be connected 115 to and from an optical line terminal (OLT) 120. The OLT 120 includes at least one PON card 125. The OLT 120 may transmit a downstream signal 135 and receive an upstream signal 145 via an optical fiber connection 130. The downstream signal 135 and the upstream signal 145 may be communicated to and from an optical multiplexer (MUX)/demultiplexer (DEMUX)/multiplexer-demultiplexer (MULDEX) 145, also referred to herein as a splitter/combiner 145, represented herein as an array waveguide. The optical MUX/DEMUX/MULDEX 145 may be connected to multiple optical network terminals (ONTs) 155, 165, . . . , 175 via optical fibers 150, 160, . . . , 170. The MUX/DEMUX/MULDEX 145 may be connected to up to thirty-two ONTs in some implementations. Each optical network terminal 155, 165, . . . , 175 may receive analog or digital downstream signals and transmit digital upstream signals from and to the OLT 120, respectively, and also to and from, respectively, end users (represented herein as 157, 158, 159 for ONT 155; 167, 168, 169 for ONT 165; and 177, 178, 179 for ONT 175, respectively).

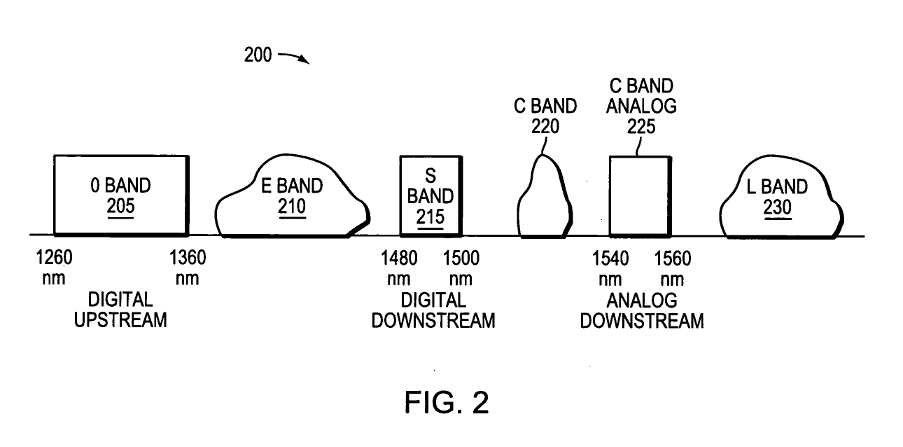

FIG. 2 depicts optical wavelength bands 200 within which digital upstream and downstream optical signals, as well as analog downstream optical signals, may be transmitted in accordance with example embodiments of the invention. According to today's definitions for the bands, the O-band 205 encompasses a wavelength range of 1260 nm to 1360 nm and may be used in accordance with some example embodiments of the invention to transmit digital upstream communications. Digital downstream communications may occur using the S-band 215, which, according to today's definition, is communicated across wavelengths ranging from 1480 nm to 1500 nm. Also according to today's definitions, C-band analog downstream communications 225 may be transmitted using wavelengths ranging from 1540 nm to 1560 nm.

There is continuous effort to upgrade and modify access network (or “network,” unless otherwise specified) bandwidth to support emerging and advanced services, such as Internet Protocol Television (IPTV). Current efforts include using optical bands (or bands) that have not previously been used for such systems, such as L and E bands, and unused portion(s) of the C-band, to support the ever increasing demand for higher bandwidths. Existing networks utilize time division multiplexing, where a wavelength is shared among multiple users through use of slots in a communications frame.

An example embodiment of the invention provides a method to transform and upgrade currently used access networks to a full wavelength division multiplexing (WDM) passive optical network (PON), where each user has his/her own wavelength or a wavelength may be shared among several users to increase density. Through use of the example embodiment for upgrading and modifying currently used bands, service providers can upgrade and modify their networks in a cost effective manner that reduces a likelihood of having to use new components that might not be available or are initially expensive.

Some example embodiments of the invention include subdividing legacy Broadband PON (BPON) or Gigabit PON (GPON) into smaller CWDM or DWDM bands to support more wavelengths. For example, the 1540 nm to 1560 nm portion of the C-band may be subdivided into multiple subbands (i.e., wavelengths within narrow bands). Each wavelength can have different video channels (e.g., CATV and/or DBS). This can be very useful if multiple franchises want to use the same PON network to reach their video customers. Simultaneously, current C-band photodiodes can receive any wavelength within the C-band, thereby requiring no changes to be made at the ONT.

The same applies to the data downstream on the S-band. DWDM channels can be added to support larger density of users or to provide higher data rate per user by allocating a separate wavelength for each user. Additionally, current S-band photodiodes can be used to detect any wavelength within the S-band, so no changes are required at the ONT. The upstream can still use a broadband 1310 nm source if there is no immediate demand to increase the upstream rate. Usually there is more demand to increase the downstream rates, especially if IPTV is to be supported to transmit downstream High Definition Television (HDTV) channels. By keeping the same broadband 1310 nm source, the industry may still use the same optics as the current PON networks. However, if increasing upstream rates becomes useful in the future, some embodiments of the invention allow for multiplexing the O-band (1260 nm-1360 nm) into smaller Coarse Wavelength Division Multiplexing (CWDM) or Dense Wavelength Division Multiplexing (DWDM) bands (i.e., subbands) to support such increases. To make the ONT more cost effective, at least one embodiment of the invention may use a broadband source in the O-band, for example, at the central office and utilize a reflective device to modulate a wave (e.g., sinusoidal carrier wave transmitted by the source) at each ONT. Unless specifically stated, example optical devices described herein are connected with other optical devices using optical fiber, and, for illustrative purposes, array waveguides are used to multiplex and demultiplex wavelengths. One with skill in the art will understand that the use of array waveguides is not specific, but rather used for illustrative purposes only.

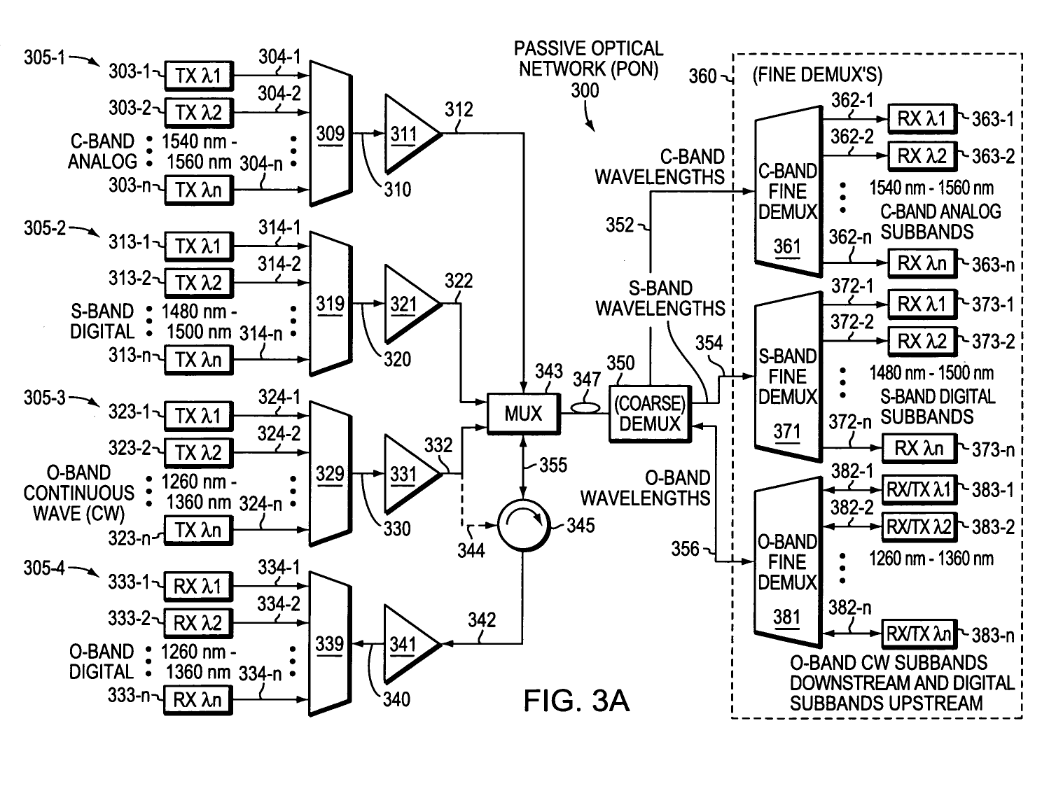

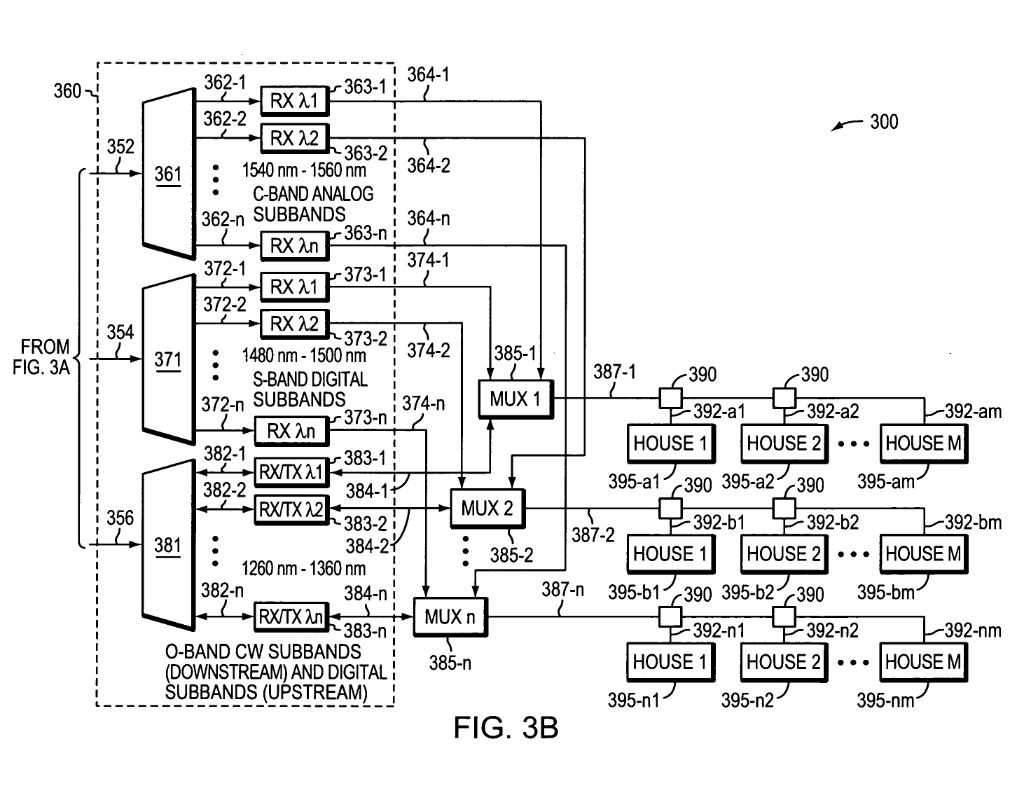

FIGS. 3A and 3B are schematic diagrams of a Passive Optical Network (PON) 300 illustrating multiple aspects of an example embodiment of the invention. In FIG. 3A, the example passive optical network (PON) 300 includes multiple transmitters, multiplexers, amplifiers, demultiplexers, and receivers that operate over some or all of the optical wavelength bands (i.e., C-, S-, or O-bands) illustrated in FIG. 2. For example, in FIG. 3A, C-band analog optical signals (1540 nm to 1560 nm) may be transmitted using multiple transmitters 303-1, 303-2, . . . , 303-n (collectively 305-1). Each transmitter may be connected via respective optical paths (e.g., optical fibers 304-1, 304-2, . . . , 304-n) to an optical combiner 309. In the example embodiment, the optical combiner 309 is connected 310 to an optical amplifier 311, which is configured to transmit a combined, single (i.e., multiplexed), C-band, analog, optical signal across an optical fiber 312 or other optical path to a multiplexer 343.

S-band digital optical signals (1480 nm to 1500 nm) may be transmitted using multiple transmitters 313-1, 313-2, . . . , 313-n (collectively 305-2). Each transmitter may communicate its respective wavelength via an optical path 314-1, 314-2, . . . , 314-n to an optical combiner 319, which may be connected 320 to an optical amplifier 321. The optical amplifier 321 is connected 322 to the multiplexer 343.

In accordance with an example embodiment of the invention, a continuous wave (CW) optical signal may be transmitted in the optical O-band (1260 nm to 1360 nm). In this example embodiment, each O-band transmitter 323-1, 323-2, . . . , 323-n (collectively 305-3) is connected via optical fibers 324-1, 324-2, . . . , 324-n to an optical multiplexer 329, which, in turn, is connected 330 to an optical amplifier 331. The optical amplifier 331 may be connected 332 to either the multiplexer 343 or may be connected 344 to a circulator 345. In a forward (i.e., downstream) path, the circulator 345 directs optical signals in a clockwise direction via an optical path 355 to the multiplexer 343, and, in a reverse (i.e., upstream) direction from the multiplexer 343, the circulator 345 directs signals in a clockwise direction, via an optical path 342, to an optical amplifier or receiver 341. The optical amplifier or receiver 341 is connected 340 to an optical demultiplexer 339, which, in this example embodiment, splits the optical signals in the O-band digital range, where each wavelength may be directed via optical paths 334-1, 334-2, . . . , 334-n to a respective receiver, herein represented as receivers 333-1, 333-2, . . . , 333-n.

In the example network 300 illustrated in FIG. 3A, the multiplexer 343 is connected to a demultiplexer (DEMUX) 350 via an optical path (e.g., optical fiber) 347. In this example embodiment, the demultiplexer 350 separates optical signal bands, combined by the multiplexer 343, back into the constituent bands (i.e., S-, C-, and O-bands). For this reason, the demultiplexer 350 may be referred to herein as a “coarse” demultiplexer 350. In this example embodiment, the respective subbands within the bands are directed as a group via optical paths 352, 354, 356 to respective “fine” demultiplexers 361, 371, 381, which separate the bands into subbands. In this example embodiment, the demultiplexer 350 may direct C-band analog signals via an optical fiber 352 to a fine demultiplexer 361 that may employ a bandpass filter (not shown) specifically to pass the optical C-band analog signal and reject S- and O-band optical signals. The C-band fine demultiplexer 361, in turn, directs specific wavelengths to respective receivers (not shown) that are configured to receive respective C-subband wavelengths, herein represented as wavelengths 363-1, 363-2, . . . , 363-n.

The coarse demultiplexer 350 may also direct optical S-band digital signals via an optical fiber 354 to an optical fine demultiplexer 371 that may employ a bandpass filter (not shown) to pass the S-band signals and reject the C- and O-band signals. The fine demultiplexer 371 separates the optical S-band into wavelengths within respective subbands, whereby each respective wavelength is directed to a specific receiver (not shown), herein represented as wavelengths 373-1, 373-2, . . . , 373-n.

The coarse demultiplexer 350 may also be configured to support optical signals in the O-band range by separating O-band signals from C- and S-band signals and sending the O-band signals via an optical fiber 356 in the forward (downstream) and reverse (upstream) directions. The coarse demultiplexer 356 may direct O-band signals to and receive from an optical “fine” demultiplexer 381 that may employ a bandpass filter (not shown) configured to pass wavelengths in the optical O-band range and reject wavelengths in the C- and S-band. The fine demultiplexer 381 may be configured to direct optical signals (i.e., wavelengths that may or may not be modulated with data) to or from transceivers configured specifically for the O-band range, herein represented as wavelengths 383-1, 383-2, . . . , 383-n.

FIG. 3B is a network diagram that illustrates the example passive optical network 300 in accordance with additional example embodiments of the invention that is configured to operate with the example PON 300 of FIG. 3A. Referring to FIG. 3B, the optical fine demultiplexers 361, 371 for the optical C- and S-bands, respectively, are configured to direct optical signals to end users, and the optical demultiplexer 381 is configured to direct optical O-band wavelengths to and from the end users, where the end users may be in houses 392a1-am, 392b1-bm, . . . , 392n1-nm.

The C-band optical fine demultiplexer 361 may be configured to separate and direct each optical subband wavelength in the C-band to a particular receiver, where the wavelengths are herein represented as wavelengths 363-1, 363-3, . . . , 363-n. The S-band optical fine demultiplexer 371 may also be configured to transmit optical signals to receivers configured to receive particular optical signals in subbands of the S-band, herein represented as wavelengths 373-1, 373-2, . . . , 373-n. The O-band optical fine demultiplexer 381 is configured to direct downstream and upstream optical signals corresponding to particular wavelength subbands, herein represented as wavelengths 383-1, 383-2, . . . , 382-n.

In one example embodiment of the network 300, each wavelength in the subbands is directed to a multiplexer (mux 1, mux 2, . . . , mux n) 385-1, 385-2, . . . , 385-n (collectively 385-1 . . . n) configured to receive subset(s) of wavelengths within the C-band, S-band or O-band range. Each multiplexer 385-1 . . . n an may then direct optical signals via: an optical path 387-1 to end users 391-a1 . . . m for multiplexer 1 (385-1), via an optical path 387-2 to end users 395-b1 . . . bm for multiplexer 2 (385-2), . . . , and via an optical path 387-n to end users 395-n1 . . . nm for multiplexer n (385-n). Optical splitters 390 are disposed in optical paths 387-1 . . . n and 392-a1 . . . am, 392-b1 . . . bm, . . . , and 392n1 . . . nm, respectively, to split power of the optical wavelengths for delivery to each end user house 395-a1 . . . am, 395-b1 . . . bm, . . . , 395-n1 . . . nm, respectively.

In another example embodiment of the network 300, multiplexers 385-1, 385-2, . . . , 385-n are not employed. Instead, individual optical paths (e.g., fibers) may span from the optical fine demultiplexers 361, 371, 381 to the houses 392-a1 . . . m, 392-b1 . . . m, 392-n1 . . . m to carry respective optical wavelengths.

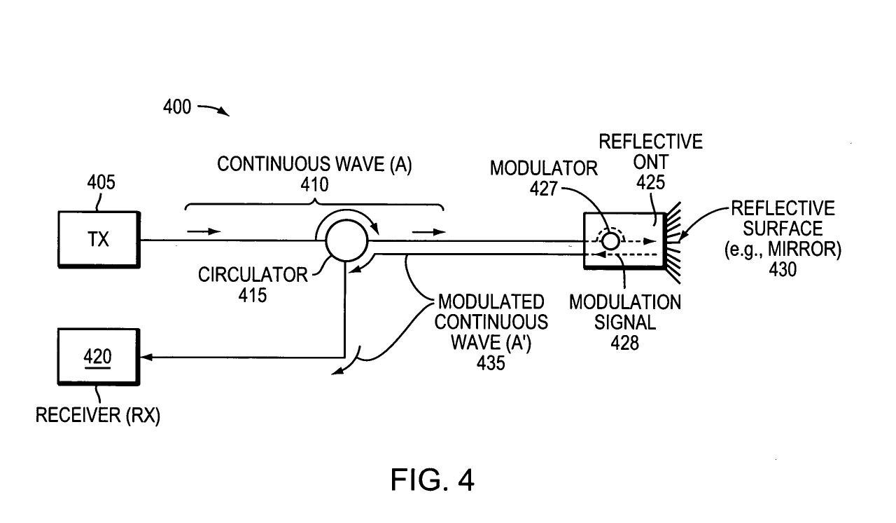

FIG. 4 is a network diagram that illustrates an example passive optical network 400 in accordance with an example embodiment of the invention illustrating the example O-band portion of the network 300 of FIGS. 3A and 3B. Referring to FIG. 4, the passive optical network (PON) 400 includes a transmitter 405 to transmit a continuous wave optical signal 410 that is directed to a circulator 415. The circulator 415 directs the continuous wave optical signal (A) 410 clockwise to a reflective ONT 425. The continuous wave optical signal 410 may be modulated by a modulator 427, according to a modulation signal 428, within the reflective ONT 425 either before or after (or both) it is reflected or otherwise caused to change direction from a forward (downstream) path to a reverse (upstream) path in the network 400. The reflective ONT 425 includes a reflective surface 430, such as a mirrored surface. In this example embodiment, the modulator 427 modulates the continuous wave optical signal 510 and sends the modulated continuous wave optical signal (A′) 435 back to the circulator 415. The circulator 415 directs the modulated signal, 435 clockwise to a receiver 420.

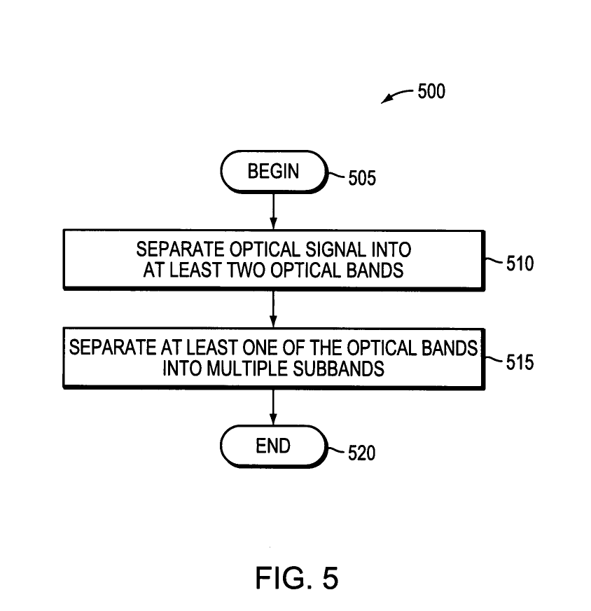

Referring again to the example network 300 illustrated in FIGS. 3A and 3B, the network 300 can be implemented in selectable combinations or subcombinations. Example combinations and subcombinations include, but are not limited to: internal network elements, such as coarse and fine demultiplexers; analog (i.e., video) and digital transmitters with subbands; optical O-band transmitters transmitting continuous wave signals (e.g., carrier wavelengths) downstream and a receiver receiving and modulating the continuous wave signals and transmitting the continuous wave signals in a modulated state upstream; combination of optical subband transmitters with optical continuous wave transmitters, such as optical C-band or optical S-band subband transmitters with optical O-band continuous wave transmitters; multiple optical O-band continuous wave transmitters; optical transceiver to modulate an optical continuous wave carrier signal received in a downstream direction and transmit a modulated signal in an upstream direction; and a full network system employing combinations or subcombinations of the aforementioned combinations and sub combinations. FIGS. 5-11 are flow diagrams illustrating example embodiments of a subset of possible combinations or subcombinations.

FIGS. 5-11 are described below with reference to optical elements as presented in the example embodiment of FIGS. 3A and 3B.

FIG. 5 is a flow diagram illustrating an example embodiment of the invention. The flow diagram 500 begins (505) and separates (510) an optical signal into a least two optical bands. The flow diagram 500 then separates (515) at least one of the optical bands into multiple subbands, then the flow diagram 500 ends (520).

The example embodiment of the invention illustrated in FIG. 5 may be implemented as an apparatus to distribute optical signals in a passive optical network with a coarse demultiplexer and at least one fine demultiplexer. The coarse demultiplexer may be configured to separate an optical signal into a least two optical bands. The at least one fine demultiplexer, in optical communication with the coarse demultiplexer, may be configured to separate a respective one of the least two optical bands into multiple subbands to distribute optical signals in the passive optical network.

The coarse and fine demultiplexers may further be configured to demultiplex analog optical signals, digital optical signals, or both. The system may also include at least one multiplexer in optical communication with at least a subset of the multiple fine demultiplexers to transmit multiple fine subbands in a multiplexed manner. The multiplexer(s) may be configured to multiplex subbands of optical signals selected from a group consisting of about 1550 nm+/−10 nm (optical C-band), 1490 nm+/−10 nm (optical S-band), and 1310 nm+/−50 nm (optical O-band). The apparatus may further include at least one optical splitter/combiner to direct the multiple fine subbands to multiple destinations in a downstream direction and combine optical signals in an upstream direction. The optical splitter/combiner may be configured to split and combine multiple fine subbands of the optical bands selected from a group consisting of about 1550 nm+/−10 nm (optical C-band), 1490 nm+/−10 nm (optical S-band), and 1310 nm+/−50 nm (optical O-band).

The coarse and fine demultiplexers may be configured to demultiplex the optical signals with wavelengths in the optical C-band, S-band, and O-band. The at least one fine demultiplexer may be configured to demultiplex the at least one optical signal band into a least two subbands in a forward direction and further configured to multiplex at least two subbands in a reverse direction. The coarse and fine demultiplexers may be configured to demultiplex coarse or dense wavelength division multiplexing (CWDM or DWDM) optical signals.

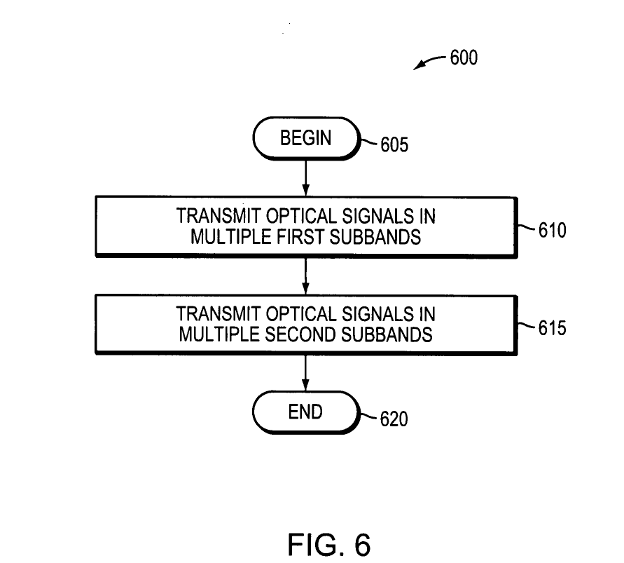

FIG. 6 is a flow diagram 600 of another example embodiment of the invention. The flow diagram 600 begins (605) and transmits (610) optical signals in multiple first subbands. The flow diagram 600 then transmits (615) optical signals in multiple second subbands, then ends (620).

The example embodiment of FIG. 6 may be implemented as an apparatus for transmitting optical signals with first optical transmitters and second optical transmitters, where the first optical transmitters may be configured to transmit optical signals in multiple first subbands of a first optical wavelength band to multiple downstream destinations in an optical network, and the second optical transmitters may be configured to transmit optical signals in multiple second subbands of a second optical wavelength band to at least a subset of the multiple downstream destinations in the optical network.

The first optical transmitters may be configured to transmit the multiple first subbands with wavelengths within about 1550 nm+/−10 nm (optical C-band). The second optical transmitters may be configured to transmit the multiple second subbands with wavelengths selected from the optical S-band or optical O-band. The first optical transmitters may further be configured to transmit analog signals in the multiple first subbands in a downstream direction in the optical network. The second optical transmitters may further be configured to transmit digital signals in the multiple second subbands in a downstream direction in the optical network.

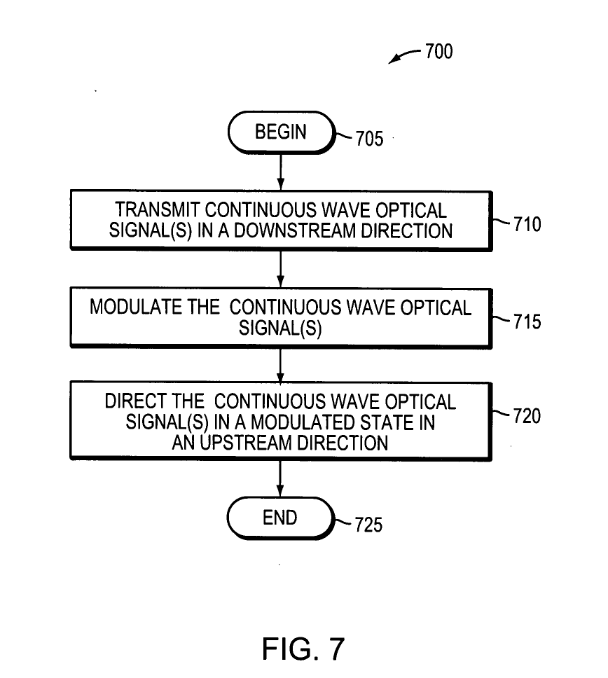

FIG. 7 is a flow diagram 700 illustrating another example embodiment of the invention. The flow diagram 700 begins (705) and transmits (710) continuous wave optical signal(s) in a downstream direction. The flow diagram then modulates (715) the continuous wave optical signal(s). The flow diagram 700 then directs (720) the continuous wave optical signal(s) in a modulated state in an upstream direction, then ends (725).

The example embodiment of FIG. 7 may be implemented as an apparatus for supporting communications in an optical network. The apparatus may include an optical transmitter configured to transmit at least one continuous wave optical signal in a downstream direction in the optical network. The apparatus may also include a first optical receiver configured to receive and modulate the at least one continuous wave optical signal to produce a modulated at least one continuous wave optical signal and direct the modulated at least one continuous wave optical signal upstream to a second optical receiver to support upstream communications in the optical network.

The first optical receiver may further be configured to reflect the at least one continuous wave optical signal. The first optical receiver may be further configured to reflect a modulated at least one continuous wave optical signal. The optical transmitter may further be configured to transmit multiple subbands composing the at least one continuous wave optical signal, with at least one of the subbands being directed to the first optical receiver. The multiple second optical receivers may be configured to receive respective modulated at least one continuous wave optical signals in the multiple subbands.

The apparatus may also include a circulator connected to first and second optical signal paths and configured to circulate the at least one continuous wave optical signal from the first optical signal path to the second optical signal path to direct the at least one continuous wave optical signal to multiple destinations via the second optical signal path. The circulator may further be connected to a third optical signal path and configured to direct the modulated at least one continuous wave optical signal from the second optical receiver to the third optical signal path. The optical transmitter may be configured to transmit the at least one continuous wave optical signal in the optical O-band.

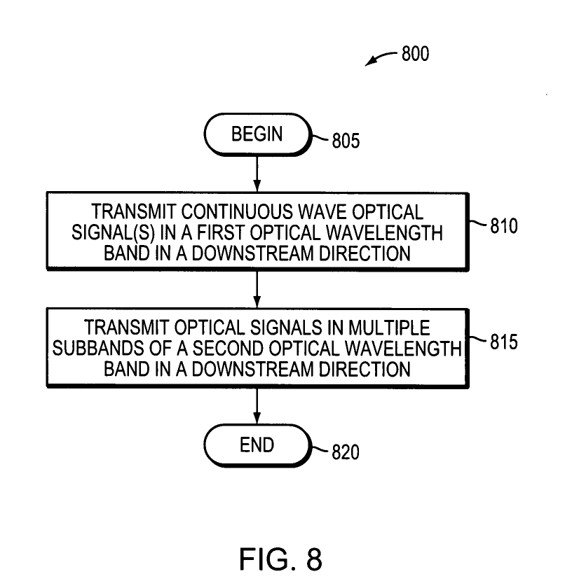

FIG. 8 is a flow diagram 800 illustrating another example embodiment of the invention. The flow diagram 800 begins (805) and transmits (810) continuous wave optical signal(s) in a first optical wavelength band in a downstream direction. The flow diagram 800 then transmits (815) optical signals in multiple subbands of a second optical wavelength band in a downstream direction. The flow diagram 800 then ends (820).

The example embodiment of FIG. 8 may be implemented as an apparatus for supporting communications in an optical network. The apparatus may include a first optical transmitter configured to transmit at least one continuous wave optical signal of a first optical wavelength band in a downstream direction in an optical network and second optical transmitter configured to transmit optical signals in multiple subbands of a second optical wavelength band to multiple downstream destinations in the optical network.

The apparatus may further include a third optical transmitter configured to transmit optical signals in multiple subbands of a third optical wavelength band to at least a subset of the multiple destinations in the optical network. The apparatus may further include a reflective receiver at each downstream destination configured to receive and reflect the at least one continuous wave optical signal. The first optical transmitter may further be configured to transmit the at least one continuous wave optical signal in multiple subbands. The second optical transmitter may be further configured to transmit the optical signals in multiple respective subbands of the second optical wavelength band.

The first optical transmitter may be configured to transmit the at least one optical continuous wave optical signal within about 1310 nm±50 nm (optical O-band), and the second optical wavelength band may be selected from a group consisting of about 1550 nm±10 nm (optical C-band) and 1490 nm±10 nm (optical S-band).

The second optical transmitter may be configured to transmit at least one continuous wave optical signal, digital signal, or both. The apparatus may further include an optical receiver to receive at least one continuous wave optical signal, digital signal, or both in an upstream direction.

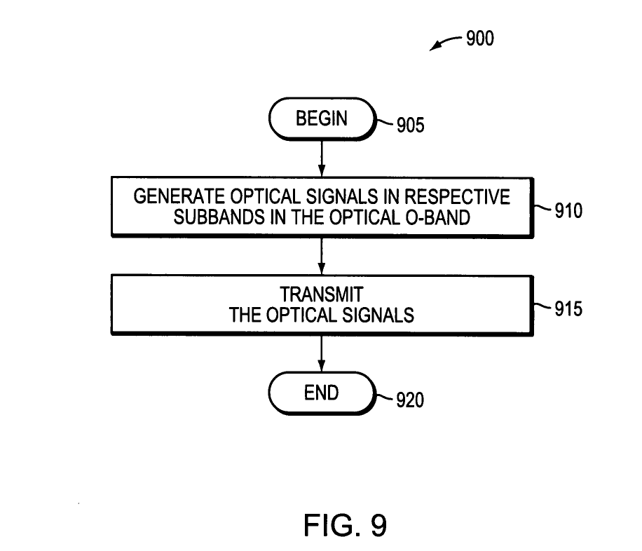

FIG. 9 is a flow diagram 900 illustrating another example embodiment of the invention. The flow diagram 900 begins (905) and generates (910) optical signals in respective subbands in the optical O-band. The flow diagram 900 then transmits (915) the optical signals. The flow diagram 900 then ends (920).

The example embodiment of FIG. 9 may be implemented as an apparatus for supporting communications in an optical network. The apparatus may include multiple continuous wavelength sources configured to generate optical signals in respective subbands in the optical O-band to provide carrier wavelengths to be modulated at network nodes other than at a network node with the sources to produce respective modulated wavelength division multiplexed optical signals.

The apparatus may further include a wavelength division demultiplexer, in an optical path between the sources and the network nodes, configured to demultiplex the optical signals into respective subbands and onto respective paths to the network nodes. The wavelength division demultiplexer may be further configured to multiplex the modulated optical signals in an upstream direction. The continuous wavelength sources may be further configured to generate the optical signals at wavelengths according to a coarse wavelength division multiplexing standard, and the continuous wavelength sources may be configured to generate optical signals at wavelengths according to a dense wavelength division multiplexing standard. The sources may further be configured to generate the optical signals with wavelengths spaced apart within a band of about 1310 nm±50 nm (optical O-band).

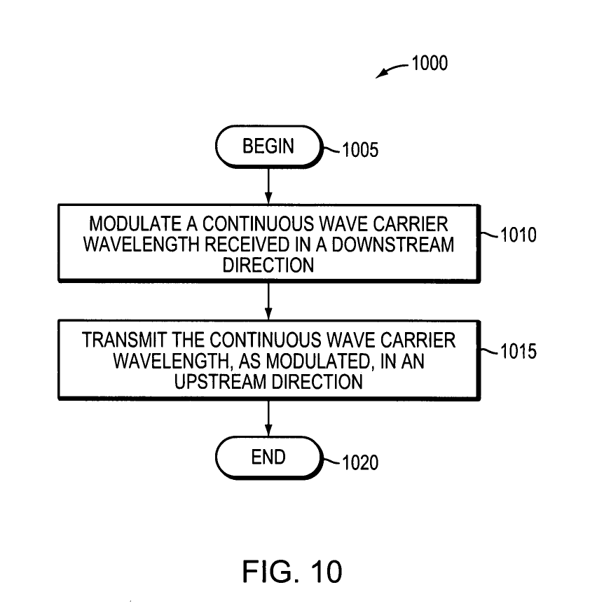

FIG. 10 is a flow diagram 1000 illustrating another example embodiment of the invention. The flow diagram begins (1005) and modulates (1010) a continuous wave carrier wavelength received in a downstream direction. The flow diagram 1000 then transmits (1015) the continuous wave carrier wavelength, as modulated, in an upstream direction. The flow diagram 1000 then ends (1020).

The example embodiment of FIG. 10 may be implemented as an optical network device including an optical transceiver coupled to an optical path to modulate a continuous wave carrier wavelength received in a downstream direction to produce a modulated optical signal and to transmit the modulated optical signal in an upstream direction via the optical path or a different upstream optical path.

The optical transceiver may be further configured to receive and transmit the modulated optical signal spaced apart within an optical wavelength band of about 1310 nm±50 nm (optical O-band), and the optical transceiver may be coupled to components in an optical network terminal.

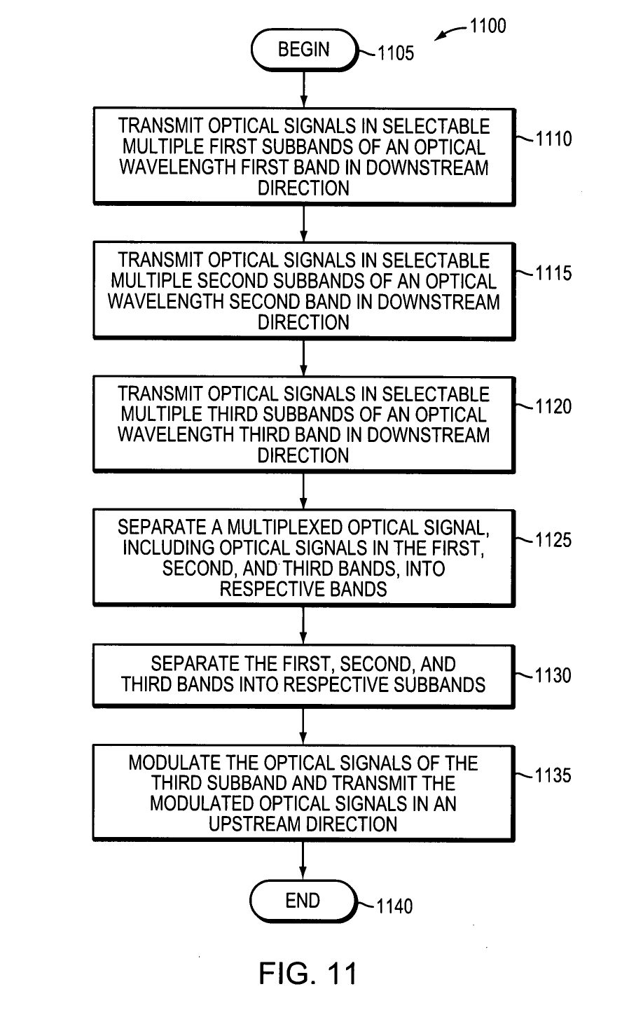

FIG. 11 is a flow diagram 1100 illustrating a full system example embodiment of the invention. The flow diagram 1100 begins (1105) and transmits (1110) optical signals in selectable multiple first subbands of an optical wavelength first band in a downstream direction. The flow diagram 1100 and transmits (1115) optical signals in selectable multiple second subbands of an optical wavelength second band in a downstream direction. The flow diagram 1100 then transmits (1120) optical signals in selectable multiple third subbands of an optical wavelength third band in a downstream direction. The flow diagram 1110 separates (1125) a multiplexed optical signal, including optical signals in the first, second, and third bands, into respective bands. The flow diagram 1100 then separates (1130) the first, second, and third bands into respective subbands. The flow diagram 1100 then modulates (1135) the optical signals of the third subband and transmits the modulated optical signals in an upstream direction. The flow diagram 1100 then ends (1140).

The example embodiment of FIG. 11 may be implemented as an optical network system including first optical transmitters configured to transmit optical signals in selectable multiple first subbands of an optical wavelength first band to at least a subset of multiple downstream destinations in an optical network, second optical transmitters configured to transmit optical signals in selectable multiple second subbands of an optical wavelength second band to at least a subset of the multiple destinations in the optical network, and third optical transmitters configured to transmit optical signals in selectable multiple third subbands of an optical wavelength third band to at least a subset of the multiple destinations in the optical network. The optical network system may further include a coarse demultiplexer configured to separate optical wavelength bands into the first, second, and third bands, fine demultiplexers configured to separate first, second, and third bands into multiple first, second, and third subbands to distribute optical signals in the optical network, and optical transceivers configured to modulate the optical signals of the third subband to produce a modulated optical signal and to transmit the modulated optical signal in an upstream direction.

The optical network system may further include at least one multiplexer coupled to at least a subset of the fine demultiplexers to transmit the multiple first, second, and third optical subbands in a multiplexed manner. The optical network system may further include at least one optical splitter/combiner to direct the multiple first, second, and third optical subbands to multiple destinations.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus to distribute optical signals in a passive optical network, the apparatus comprising:
a coarse demultiplexer configured to separate an optical signal into at least two optical bands; and
at least one fine demultiplexer, in optical communication with the coarse demultiplexer, configured to separate a respective one of the at least two optical bands into multiple subbands to distribute optical signals in the passive optical network.

2. The apparatus as claimed in claim 1 wherein the coarse and fine demultiplexers are further configured to demultiplex analog optical signals, digital optical signals, or both.

3. The apparatus as claimed in claim 1 further including at least one multiplexer coupled to at least a subset of the multiple fine demultiplexers to transmit multiple fine subbands in a multiplexed manner.

4. The apparatus as claimed in claim 3 wherein the at least one multiplexer is configured to multiplex subbands of optical bands selected from a group consisting of about 1550 nm±10 nm (optical C-band), 1490 nm±10 nm (optical S-band), and 1310 nm±50 nm (optical O-band).

5. The apparatus as claimed in claim 4 further including at least one optical splitter/combiner to direct the multiple fine subbands to multiple destinations in a downstream direction and combine optical signals in an upstream direction.

6. The apparatus as claimed in claim 5 wherein the optical splitter/combiner is configured to split and combine multiple fine subbands of optical bands selected from a group consisting of about 1550 nm±10 nm (optical C-band), 1490 nm±10 nm (optical S-band), and 1310 nm±50 nm (optical O-band).

7. The apparatus as claimed in claim 1 wherein the coarse and fine demultiplexers are configured to demultiplex the optical signal with wavelengths selected from a group consisting of 1550 nm±10 nm (optical C-band), 1490 nm±10 nm (optical S-band), and 1310 nm±50 nm (optical O-band).

8. The apparatus as claimed in claim 1 wherein the at least one fine demultiplexer is configured to demultiplex the at least one optical signal band into at least two subbands in a forward direction and further configured to multiplex at least two subbands in a reverse direction.

9. The apparatus as claimed in claim 1 wherein the coarse and fine demultiplexers are configured to demultiplex coarse or dense wavelength division multiplexing optical signals.

10. A method for distributing optical signals in a passive optical network, the apparatus comprising:
separating an optical signal into at least two optical bands in a passive optical network; and
separating at least one of the at least two optical bands into multiple subbands to distribute optical signals in the passive optical network.

11. The method as claimed in claim 10 wherein separating the optical signal into multiple bands and subbands includes separating analog optical signals, digital optical signals, or both, into at least two optical bands and subbands, respectively.

12. The method as claimed in claim 10 further including multiplexing at least one subset of the multiple subbands into a multiplexed subset.

13. The method as claimed in claim 12 wherein multiplexing the at least one subset of the multiple subbands includes multiplexing subbands of optical bands selected from a group consisting of about 1550 nm±10 nm (optical C-band), 1490 nm±10 nm (optical S-band), and 1310 nm±50 nm (optical O-band).

14. The method as claimed in claim 12 further including splitting the multiplexed subset to direct the multiplexed subset in a downstream direction to multiple destinations in a downstream direction and combining upstream optical signals in an upstream direction.

15. The method as claimed in claim 14 wherein splitting the multiplexed subgroup includes splitting power of multiple subbands selected from a group consisting of about 1550 nm±10 nm (optical C-band), 1490 nm±10 nm (optical S-band), and 1310 nm±50 nm (optical O-band).

16. The method as claimed in claim 10 wherein demultiplexing the optical signal includes demultiplexing the optical signal with wavelengths selected from a group consisting of about 1550 nm±10 nm (optical C-band), 1490 nm±10 nm (optical S-band), and 1310 nm±50 nm (optical O-band).

17. The method as claimed in claim 10 wherein demultiplexing the at least two optical bands includes demultiplexing at least one of the at least two optical bands into at least two subbands in a forward direction and multiplexing at least two subbands in a reverse direction.

18. The method as claimed in claim 1 wherein separating the optical signal further includes operating on coarse or dense wavelength division multiplexing optical signals.

19-65. (canceled)
